(19) United States
(12) Patent Application Publication
(10) Pub. No.: US 2023/0299525 A1
(43) Pub. Date: Sep. 21, 2023

(54) Electrical Contact Sleeve with Low Insertion Force

(71) Applicant: TE Connectivity Germany GmbH, Bensheim (DE)

(72) Inventor: Olivier De Cloet, Bensheim (DE)

(73) Assignee: TE Connectivity Germany GmbH, Bensheim (DE)

(21) Appl. No.: 18/184,214

(22) Filed: Mar. 15, 2023

(30) Foreign Application Priority Data
Mar. 16, 2022 (DE) 102022106159.0

(51) Int. Cl. H01R 13/11; H01R 13/18

(52) U.S. Cl. CPC H01R 13/113; H01R 13/18

(57) ABSTRACT

An electrical contact sleeve includes a contact spring extending in a longitudinal direction from a base to an end of the electrical contact sleeve on a connector side. The contact spring has a recess and a plurality of spring legs adjoining the recess in a circumferential direction. The spring legs unite to form a free end of the contact spring.

### CROSS-REFERENCE TO RELATED APPLICATIONS

This application claims the benefit of the filing date under 35 U.S.C. § 119(a)-(d) of German Patent Application No. 102022106159.0, filed on Mar. 16, 2022.

### FIELD OF THE INVENTION

The invention relates to an electrical contact sleeve.

### BACKGROUND

Electrical contact sleeves are used for various applications from the low-frequency range to the high-frequency range for electrically contacting a mating contact that can be inserted into the contact sleeve. Depending on the choice of material, which may be necessary due to robustness, high contact normal forces can arise. High contact normal forces lead to high insertion forces due to the increased friction caused by the contact normal force between the contact sleeve and the mating contact. There is a need for a robust electrical contact sleeve that simultaneously ensures low insertion forces.

### SUMMARY

An electrical contact sleeve includes a contact spring extending in a longitudinal direction from a base to an end of the electrical contact sleeve on a connector side. The contact spring has a recess and a plurality of spring legs adjoining the recess in a circumferential direction. The spring legs unite to form a free end of the contact spring.

### BRIEF DESCRIPTION OF THE DRAWINGS

Exemplary embodiments of the invention are described by way of the following drawings. In the drawings:

FIG. 1 shows a schematic perspective view of an exemplary configuration of an electrical contact sleeve;

FIG. 2 shows a further schematic perspective view of the exemplary configuration of the electrical contact sleeve from FIG. 1;

FIG. 3 shows a schematic side view of a plug arrangement comprising the exemplary configuration of the electrical contact sleeve and a mating contact inserted into the contact sleeve; and

FIG. 4 shows a schematic detailed view of a section of the plug arrangement from FIG. 3.

### DETAILED DESCRIPTION OF THE EMBODIMENT(S)

In the following, the invention shall be described by way of example in more detail using embodiments with reference to the appended figures. Elements in the figures that correspond to one another in terms of structure and/or function are provided with the same reference characters.

The combinations of features shown and described in the individual embodiments are for explanatory purposes only. In accordance with the explanations herein, a feature of an embodiment can be dispensed with if its technical effect is of no significance for a particular application. Conversely, in accordance with the above explanations, a further feature can be added in an embodiment should its technical effect be advantageous or necessary for a particular application.

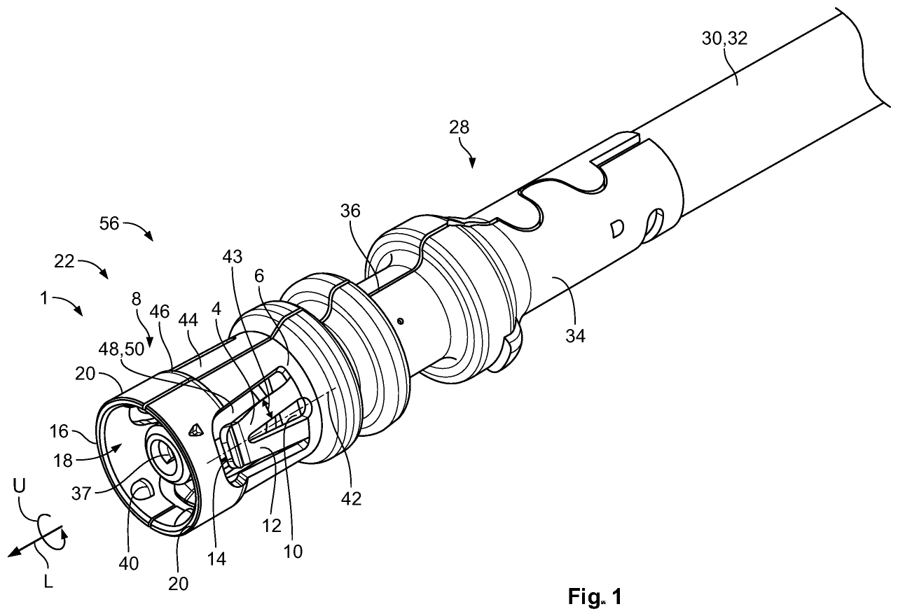

An exemplary configuration of an electrical contact sleeve 1 shall now be explained in more detail hereafter with reference to FIGS. 1 to 4. The electrical contact sleeve 1 can be a contact sleeve for a coaxial connector. In particular, the electrical contact element can be configured for a coaxial high-frequency connector in a range from approximately 3 MHz to approximately 20 GHz. An electrical connector can comprise at least one contact sleeve 1 according to at least one of the configurations described for contacting a mating connector.

Electrical contact sleeve 1 for contacting a mating contact 2 comprises a plurality of contact springs 4 which are arranged to be spaced from one another in a circumferential direction U and extend along a longitudinal direction L from a common base 6 to an end 8 of contact sleeve 1 on the connector side, where contact springs 4 each comprise a recess 10 and spring legs 12 which adjoin recess 10 in the circumferential direction U and which unite to form a free end 14. If the term “contact spring” is used in the plural form hereafter, then this shall include both a configuration with a single contact spring 4 as well as a configuration with a plurality of contact springs 4.

The at least one or more contact springs 4 can be arranged at the end on the connector side. In particular, the free end of the at least one contact spring 4 can be located towards the end on the connector side. A foot of the contact springs 4, with which the contact springs 4 are connected to the remainder of the sleeve, in particular to the common base 6, can be facing towards the end on the cable side.

The two or more contact springs 4 can be arranged uniformly in the circumferential direction U, in particular equigonally, around a receptacle 18. “Equigonal” means that the contact springs 4 are spaced equiangularly from each other. For example, the contact sleeve 1 can comprise two contact springs 4 arranged diametrically with respect to one another. The contact sleeve 1 may comprises three contact springs 4 which are arranged at 120° angles to one another. The central axes of the contact springs 4 can be arranged in particular equigonally.

A uniform deflection of the at least one contact spring 4 can be obtained if the longitudinal direction of the contact sleeve 1 runs substantially parallel to an axis of symmetry of the respective contact spring 4. The axis of symmetry of the respective contact spring 4 may extend through the recess 10.

The recess 10 may have an elongate footprint. The recess 10 can extend in particular away from the base 6 towards the free end of the corresponding contact spring 4. This allows for a better distribution of tension for the individual contact springs 4 as they are deflected. Greater flexibility can be obtained if the recess 10 passes through the respective contact spring 4.

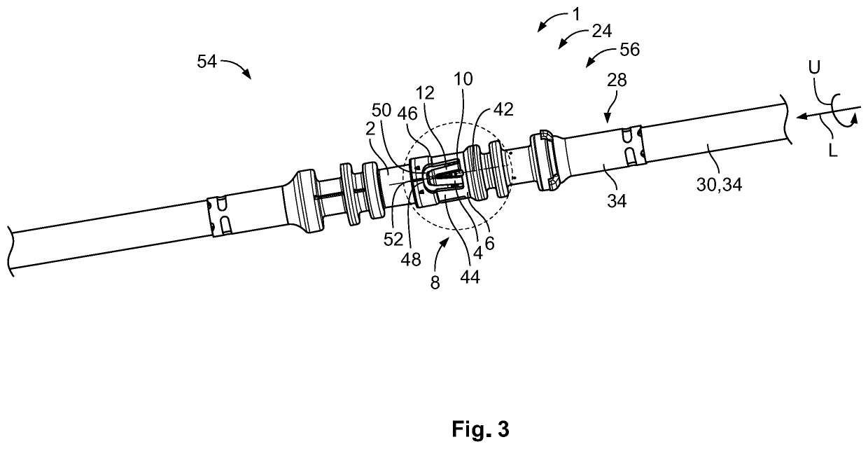

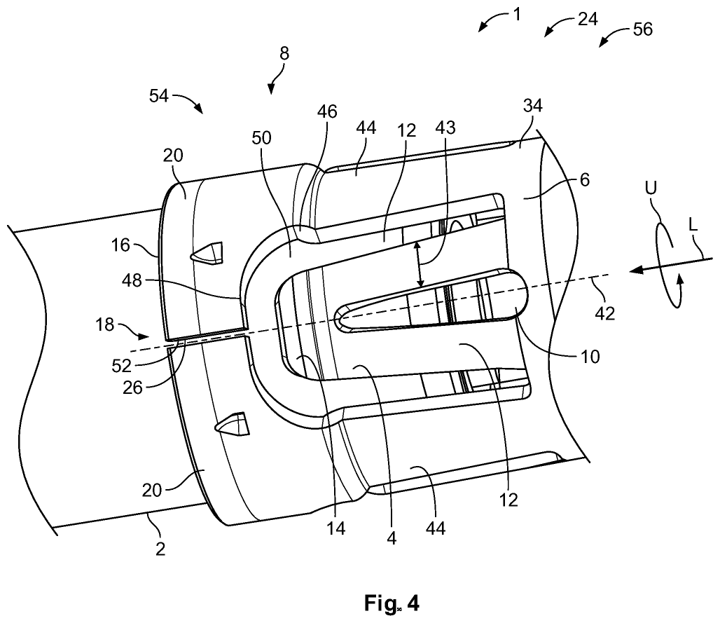

According to the exemplary embodiment, contact sleeve 1 additionally comprises a ring 16 which is arranged on an end 8 on the connector side and which extends around the receptacle 18. Ring 16 is composed of two ring segments 20 which, in a non-contacting relaxed initial state 22, jointly close the ring 16 at at least one point and, in a deflected contacting state 24 (see FIGS. 3 and 4), are spaced from one another at at least two points 26 in circumferential direction U.

A ring 16 in which the ring segments are spaced due to manufacturing tolerance is also considered to be a closed ring 16. Accordingly, the ring segments can be spaced from one another in the non-contacting relaxed initial state by, for example, up to 0.05 mm and can be spaced from one another in a deflected contacting state by more than 0.05 mm at at least two points in the circumferential direction U.

The recess 10 at the at least one contact spring 4 increases the elasticity of the contact spring 4. The spring legs 12 form individual lever arms, as a result of which the at least one contact spring 4 can be deflected more easily. The tension of the at least one contact spring 4 is reduced by the recess 10. However, sufficiently high contact normal force can be guaranteed since the spring legs 12 unite at the free end. This at least one contact spring 4 is in particular more robust than individual separate spring legs 12. This prevents the at least one contact spring 4 from being plastically deformed, for example, in the event of incorrect insertion.

The exemplary configuration shows a contact sleeve 1 with a combination of contact springs 4 and ring 16. However, it is also conceivable that ring 16 in another configuration composed of the ring segments or contact springs 4 provided with the recesses, respectively, are not implemented.

The axial direction of the contact sleeve 1 is hereafter used as a synonym for the longitudinal direction. Longitudinal direction L can run in particular parallel to an insertion direction in which mating contact 2 is inserted into contact sleeve 1.

The ring 16 arranged at the end on the connector side encloses the receptacle 18 and prevents the mating contact 2 from being inserted into the receptacle 18 at an angle. The ring 16 thereby prevents the mating contact 2 from being incorrectly inserted into the receptacle 18. Furthermore, due to its pretension, the ring 16 is configured such that the ring segments close the ring 16 at least at one point, as a result of which a high contact normal force can be ensured. If the mating contact 2 is now inserted into the receptacle 18, the ring segments 20 can deflect away from one another, which reduces the insertion force even with a robust contact sleeve 1. In order to distribute the contact normal force uniformly over the ring segments 20, the ring segments 20 can be of equal length in the circumferential direction U.

Contact sleeve 1 can extend in longitudinal direction L from end 8 on the connector side to an end 28 on the cable side. At end 28 on the cable side, contact sleeve 1 can be attached to an electrical cable 30, in particular a coaxial cable 32. For example, contact sleeve 1 can be attached to cable 30 by way of a crimp connection.

Contact sleeve 1 may be a punched and bent member 34 which has been bent to the sleeve shape. Accordingly, contact sleeve 1 can have a production-related seam 36 which in particular extends end-to-end from end 8 on the connector side to end 28 on the cable side. To improve the stability of contact sleeve 1, at least one welding point can be provided at which contact sleeve 1 is welded together. In particular, the sections of contact sleeve 1 adjoining the seam can be welded together. If this is the case, then the welding point is arranged at a distance from ring 16 in longitudinal direction L. For example, the welding point can be arranged at end 28 on the cable side. This allows for greater flexibility of contact sleeve 1 at end 8 on the connector side.

Contact sleeve 1 can have a material thickness in the radial direction of at least 0.3 mm. This quite high level of material thickness increases the contact normal force that can be obtained and also meets the strict requirements with regard to the mechanical robustness of contact sleeve 1. With conventional contact sleeves 1, such a high level of material thickness would lead to particularly high insertion forces. In combination with the contact springs 4 provided with recesses and/or the ring 16 composed of ring segments, the insertion forces are kept low even with a contact sleeve 1 having a high level of material thickness.

Contact sleeve 1 is suitable for contacting a coaxial connector. For this purpose, contact sleeve 1 comprises an inner conductor contact 37 arranged in the receptacle. Contact springs 4 are provided with contact surfaces 38 for contacting an outer conductor of the coaxial connector. The number of points of contacting the outer conductor can be further increased by providing ring segments 20 with contact curvatures 40 projecting radially inwardly. Three contact springs 4 and four contact curvatures 40 are shown in this exemplary configuration. Accordingly, a total of seven points of contacting arises.

The contact springs 4 can be configured, in particular, to be self-supporting. As can best be seen in FIG. 4, the contact springs 4 can taper in longitudinal direction L away from base 6. This allows for optimal tension distribution in contact spring 4 under load.

Contact springs 4 can be configured symmetrically, in particular axially symmetrically, to an axis of symmetry 42 for uniform distribution of the tension. Axis of symmetry 42 of contact spring 4 can run substantially parallel to longitudinal direction L.

Axis of symmetry 42 can extend along recess 10. Recess 10 extends in an embodiment from base 6 to free end 14 and tapers uniformly to the taper of contact spring 4. Accordingly, it can be ensured that spring legs 12 have a width 43 which extends in the circumferential direction and which is constant or uniform along recess 10 up to free end 14. The width at free end 14 can be formed by the two united spring legs. The width can therefore be up to twice the width 43 of an individual spring leg 12.

Recess 10 can extend in longitudinal direction L into base 6 so that a section of base 6 is also penetrated. This improves the flexibility of contact spring 4 and thereby reduces the insertion force. As can be seen in FIG. 4, recess 10 in a radial top view can have a substantially teardrop-shaped or drop-shaped footprint.

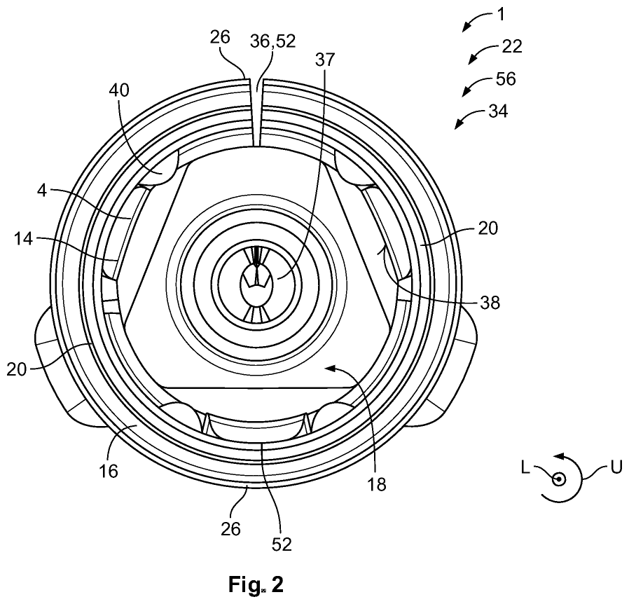

FIG. 2 shows that contact springs 4 can be distributed uniformly in circumferential direction U. For example, three contact springs 4 whose axes of symmetry 42 are arranged with 120° spacing are present in the exemplary configuration.

Ring 16 can be configured such that it covers contact springs 4 at least in part in a top view along longitudinal direction L. In this way it can be prevented that contact springs 4 are bent in the event of incorrect insertion. The contact curvatures 40 can be embossings, as a result of which the actual material thickness at the points of contact curvatures 40 does not change significantly.

In the exemplary configuration, ring segments 20 are formed on end faces of spring arms 44 which extend along longitudinal direction L from a common base 6 and are spaced from one another in circumferential direction U. Spring arms 44 increase the flexibility of contact sleeve 1 and allow for ring segments 20 to be deflected further away from one another. Spring arms 44 and contact springs 4 can project from common base 6 in longitudinal direction L substantially parallel to one another. Consequently, spring arms 44 and contact springs 4 can extend from a common height in longitudinal direction L.

In an embodiment, the spring arms 44 are longer than contact springs 4, since this can prevent ring segments 20 from impeding the deflection of contact springs 4.

The exemplary configuration shows a contact sleeve 1 with a total of four spring arms 44, where two spring arms 44 are connected to one another by way of a common ring segment 20. One respective spring arm 44 of ring segments 20 can adjoin seam 36. On the other side, ring segments 20 can project from spring arm 44 on both sides in circumferential direction U. The projecting parts of ring segments 20 can therefore strike against each other beyond seam 36. Spring arms 44 may have an offset 46 such that ring segments 20 are offset radially outwardly with respect to the remainder of spring arms 44.

In order to obtain simultaneous contacting by way of contact curvatures 40, the contact curvatures can be arranged in longitudinal direction L at a common height, as a result of which simultaneous and uniform contacting can be achieved.

The contact springs 4 can be spaced from the ring segments 20 in the axial direction. In particular, the free end can be disposed in the axial direction between the base 6 and the ring segments 20. Furthermore, contact springs 4 can be spaced from spring arms 44 in circumferential direction U. At least one contact spring 4 can be spaced from spring arms 44 on three narrow sides. Accordingly, at least one contact spring 4 can be configured to be self-supporting, where at least one contact spring 4 is protected from mechanical loads by adjacent spring arms 44.

Spring arms 44 can form an arc 48 with ring segments 20 which, together with base 6, encloses an opening 50. One respective contact spring 4 can extend along longitudinal direction L from base 6 into opening 50, so that the contact spring 4 extends into the receptacle 8. The contact springs 4 are pretensioned inwardly in the radial direction. In particular, a contact surface of the contact spring 4 formed at the free end can project in the radial direction through the opening 50 into the receptacle 8.

In an embodiment, the contact springs 4 can be shorter than the spring arms 44. Accordingly, the contact springs 4 in an embodiment form no ring segment.

In the relaxed initial state, ring segments 20 can be supported on one another at at least one point. For example, ring segments 20 can strike against one another in circumferential direction U at the height of an axis of symmetry 42 of a contact spring 4.

If mating contact 2 is now inserted into contact sleeve 1, then ring segments 20 are deflected in the direction away from one another. A slot 52, by which ring segments 20 are separated from one another, is thus formed. Ring segments 20 can also be separated from one another by a sot formed by seam 36, where the width of the slot in the inserted state can increase in the circumferential direction U.

The at least two slots 52 are arranged diametrically with respect to one another. For example, exactly two ring segments 20 which extend approximately by 180° can be provided. The ring segments 20 can be separated from one another at both ends by slots 52. In the relaxed initial state, the ring segments 20 can close at least one, and in an embodiment all, slots 52. Accordingly, the ring 16 is closed at this point solely by the pretension force of the ring segments 20 or spring arms 44, respectively. If the mating contact 2 is now inserted into the sleeve 1, the ring segments 20 can be deflected away from one another, as a result of which the ring 16 is interrupted by the slot 52.

Within the meaning of the application, a plurality of spring arms 44, ring segments 20, or contact springs 4 means two to ten spring arms 44, ring segments 20, or contact springs 4. The number of contact springs 4 can be fewer than the number of spring arms 44. For example, the contact sleeve 1 can comprise four spring arms 44 and three contact springs 4.

FIGS. 3 and 4 show a plug connection 54 with an electrical connector 56 which comprises at least one contact sleeve 1 and a mating contact 2 which is inserted into contact sleeve 1. In the contacting state 24, contact springs 4 and ring segments 20 are deflected radially outwardly. This deflection is achieved by recesses 10 in the contact springs or ring segments 20 that are separated from one another, respectively.

What is claimed is:

1. An electrical contact sleeve, comprising:
a contact spring extending in a longitudinal direction from a base to an end of the electrical contact sleeve on a connector side, the contact spring has a recess and a plurality of spring legs adjoining the recess in a circumferential direction, the spring legs unite to form a free end of the contact spring.

2. The electrical contact sleeve of claim 1, wherein the longitudinal direction runs parallel to an axis of symmetry of the contact spring.

3. The electrical contact sleeve of claim 1, wherein the recess extends from the base toward the free end of the contact spring.

4. The electrical contact sleeve of claim 1, wherein the recess tapers in a direction away from the base.

5. The electrical contact sleeve of claim 1, wherein the spring legs have a uniform width along the recess.

6. The electrical contact sleeve of claim 1, further comprising a ring at the end on the connector side, the ring extending around a receptacle.

7. The electrical contact sleeve of claim 6, wherein the ring has a pair of ring segments.

8. The electrical contact sleeve of claim 7, wherein the ring segments jointly close the ring at at least one point in a non-contacting relaxed initial state.

9. The electrical contact sleeve of claim 8, wherein the ring segments are spaced from one another at at least two points in the circumferential direction in a deflected contacting state.

10. The electrical contact sleeve of claim 9, wherein at least one of the ring segments has a contact curvature projecting into the receptacle in a radial direction.

11. The electrical contact sleeve of claim 9, wherein the pair of ring segments are formed on a plurality of end faces of a plurality of spring arms that extend away from a common base and are spaced from one another in the circumferential direction.

12. The electrical contact sleeve of claim 11, wherein the spring arms are connected by a common ring segment.

13. The electrical contact sleeve of claim 7, wherein the contact spring is spaced from the ring segments.

14. The electrical contact sleeve of claim 12, wherein the contact spring is spaced from the ring segments.

15. The electrical contact sleeve of claim 14, wherein the contact spring and the spring arms extend away from the common base and are spaced from one another in the circumferential direction.

16. The electrical contact sleeve of claim 15, wherein the contact spring is shorter than the spring arms.

17. The electrical contact sleeve of claim 1, wherein the contact spring extends along an opening of the contact sleeve.

18. The electrical contact sleeve of claim 7, wherein the ring segments are separated from one another by a pair of slots.

19. The electrical contact sleeve of claim 18, wherein the slots are arranged diametrically with respect to one another.

20. The electrical contact sleeve of claim 1, wherein the contact sleeve has a material thickness of at least 0.3 mm.
